(19) United States
(12) Patent Application Publication
(10) Pub. No.: US 2022/0150421 A1
(43) Pub. Date: May 12, 2022

(54) IMAGE PROCESSING APPARATUS, IMAGE PROCESSING METHOD, PROGRAM, AND IMAGING APPARATUS

(71) Applicant: SONY GROUP CORPORATION, TOKYO (JP)

(72) Inventors: TOSHIAKI UEDA, TOKYO (JP); TOMOYA OUCHI, TOKYO (JP); TAKAYUKI HATANAKA, TOKYO (JP)

(21) Appl. No.: 17/441,103

(22) PCT Filed: Jan. 7, 2020
(86) PCT No.: PCT/JP2020/000145

§ 371 Date: Sep. 20, 2021

(30) Foreign Application Priority Data
Mar. 29, 2019 (JP) 2019-066234

(51) Int. Cl. H04N 5/272; H04N 5/232; H04N 5/262

(52) U.S. Cl. CPC H04N 5/272; H04N 5/2628; H04N 5/23203

(57) ABSTRACT

A sub imaging apparatus 60 used by a user generates a sub captured image by imaging a subject OB. A main imaging apparatus 20 of which an imaging direction can be changed by a camera platform 40 is remotely controlled by the sub imaging apparatus 60 to image the subject imaged by the sub imaging apparatus 60 so as to generate a main captured image with an angle of view different from that of the sub captured image. An image combination section included in the sub imaging apparatus 60 generates a display image by combining the sub captured image generated by the sub imaging apparatus 60 with the main captured image generated by the main imaging apparatus 20. A display section included in the sub imaging apparatus 60 displays the display image generated by the image combination section. Using the sub imaging apparatus 60, the user may cause the main imaging apparatus 20 away from the sub imaging apparatus 60 to image a desired subject easily. The user may further verify the subject by using captured images with different angles of view.

### TECHNICAL FIELD

The present technology relates to an image processing apparatus, an image processing method, a program, and an imaging apparatus. The technology enables easy imaging of a subject of interest in a case where a user is away from the imaging apparatus.

### BACKGROUND ART

Heretofore, when an imaging apparatus is used to perform telephoto imaging, a narrow angle of view at the timing of imaging can make it difficult to find the subject once it is lost sight of while the composition of the image is being verified. To overcome this inconvenience, PTL 1 proposes, for example, that a first image and a second image be used in such a manner that an imaging range frame of the image with the narrower imaging range of the two is superposed on the image with the wider imaging range, the first image being generated by a camera body by using a body lens, the second image being generated by an attachment to the camera body by using an attachment lens with an angle of view different from that of the body lens.

### CITATION LIST

### Patent Literature

[PTL 1]
JP 2013-235195A

### SUMMARY

### Technical Problem

According to PTL 1, the attachment is mounted on the camera body, so that the image with the wider imaging range includes the imaging range frame of the image with the narrower imaging range. Where the camera body is separated from the attachment, however, there occur cases in which the image with the wider imaging range excludes the imaging range frame of the image with the narrower imaging range. This makes it difficult to find the subject within the range.

In view of the above, the present technology is aimed at providing an image processing apparatus, an image processing method, a program, and an imaging apparatus for enabling easy imaging of a subject of interest in a case where a user is away from the imaging apparatus.

### Solution to Problem

According to a first aspect of the present technology, there is provided an image processing apparatus including an image combination section configured to generate a display image by combining a sub captured image generated by a sub imaging apparatus imaging a subject, with a main captured image generated by a main imaging apparatus imaging the subject, the main imaging apparatus being remotely controlled by the sub imaging apparatus.

According to the present technology, the sub imaging apparatus generates the sub captured image by imaging the subject. Further, the main imaging apparatus remotely controlled by the sub imaging apparatus generates the main captured image with an angle of view different from that of the sub captured image, by imaging the subject imaged by the sub imaging apparatus, for example. The image combination section generates the display image by combining the sub captured image generated by the sub imaging apparatus with the main captured image generated by the main imaging apparatus.

Further, the image combination section switches the image combination operation depending either on a result of comparison between a parallax between the main imaging apparatus and the sub imaging apparatus at a time of imaging the subject on one hand and a predetermined first threshold value on the other hand, or on a result of comparison between the parallax on one hand and the first threshold value and a second threshold value larger than the first threshold value on the other hand. A parallax calculation section calculates the parallax on the basis of a distance to the subject imaged by the sub imaging apparatus and of a motion following an initial state in which the sub imaging apparatus and the main imaging apparatus are placed.

In a case where the parallax is equal to or smaller than the first threshold value, the image combination section generates the display image by combining the sub captured image with the main captured image. For example, the image combination section may generate the display image by superposing on either the sub captured image or the main captured image, whichever has a wider angle of view, the other captured image. Alternatively, the image combination section may generate the display image by scaling down either the sub captured image or the main captured image, whichever has a wider angle of view, and by superposing the scaled-down captured image on the other captured image. Further, in a case where the parallax is larger than the first threshold value and is equal to or smaller than the second threshold value, the image combination section may generate the display image by superposing on either the sub captured image or the main captured image, whichever has a wider angle of view, an imaging region indication indicative of an imaging range of the other captured image. For example, the sub captured image is caused to have a wider angle of view than the main captured image, with the image combination section generating the display image by superposing on the sub captured image the imaging region indication indicative of the range imaged by the main imaging apparatus. Further, in a case where the parallax calculated by the parallax calculation section is larger than the second threshold value, the image combination section generates the display image by placing on either the sub captured image or the main captured image a focus position indication indicative of a focus position of the other captured image. For example, the sub captured image is caused to have a wider angle of view than the main captured image, with the image combination section generating the display image by superposing on the sub captured image the focus position indication indicative of the focus position of the main imaging apparatus.

According to a second aspect of the present technology, there is provided an imaging processing method including causing an image combination section to generate a display image by combining a sub captured image generated by a sub imaging apparatus imaging a subject, with a main captured image generated by a main imaging apparatus imaging the subject, the main imaging apparatus being remotely controlled by the sub imaging apparatus.

According to a third aspect of the present technology, there is provided a program for causing a computer to perform a procedure of, generating a display image by combining a sub captured image generated by a sub imaging apparatus imaging a subject, with a main captured image generated by a main imaging apparatus imaging the subject, the main imaging apparatus being remotely controlled by the sub imaging apparatus.

Incidentally, the program of the present technology may be offered in a computer-readable format to a general-purpose computer capable of executing diverse program codes by using storage media such as optical discs, magnetic discs, or semiconductor memories, or via communication media such as networks. When provided with such a program in a computer-readable manner, the computer performs the processes defined by the program.

According to a fourth aspect of the present technology, there is provided an imaging apparatus including an imaging section configured to image a subject, a distance measurement section configured to measure a distance to the subject imaged by the imaging section, a motion sensor section configured to measure a motion following an initial state, a communication section configured to transmit to a main imaging apparatus the distance measured by the distance measurement section and subject position information indicative of the motion measured by the motion sensor section, an image combination section configured to generate a display image by combining a sub captured image generated by the imaging section, with a main captured image generated by a main imaging apparatus of which an imaging direction is controlled on the basis of the subject position information, and a display section configured to display the display image generated by the image combination section.

According to the present technology, a hold section holds the display section, the imaging section, and the distance measurement section in such a manner that the display section is positioned at an eye of a user, that the imaging section is positioned to image what appears straight in front of the user, and that the distance measurement section is positioned to measure the distance to the subject straight in front of the user. The imaging section images the subject, with the distance measurement section measuring the distance to the subject imaged by the imaging section. The motion sensor section measures the motion following the initial state. The initial state is a state in which the distance measurement section and the main imaging apparatus are made to face each other. The distance to the main imaging apparatus as measured by the distance measurement section and the direction of the main imaging apparatus are used as a reference for the motion. The communication section transmits to the main imaging apparatus the distance measured by the distance measurement section and the subject position information indicative of the motion measured by the motion sensor section. The image combination section generates the display image by combining the sub captured image generated by the imaging section, with the main captured image generated by the main imaging apparatus of which the imaging direction is controlled on the basis of the subject position information. The display section displays the display image generated by the image combination section.

### BRIEF DESCRIPTION OF DRAWINGS

FIG. 1 is a diagram depicting a configuration of an imaging system.

FIG. 2 is a diagram depicting a typical sub imaging apparatus.

FIG. 3 is a diagram depicting a typical configuration of the imaging system.

FIG. 4 is a diagram depicting a typical functional configuration of an imaging control section.

FIG. 5 is a flowchart depicting typical operations of the imaging system.

FIG. 6 is a diagram for explaining operations of a subject position calculation section in the imaging control section.

FIG. 7 is a diagram for explaining other operations of the subject position calculation section in the imaging control section.

FIG. 8 is a diagram depicting typical operations to generate a display image.

FIG. 9 is a flowchart depicting typical image combination operations.

FIG. 10 is a diagram depicting typical operations of an image combination section.

FIG. 11 is a diagram depicting typical display images.

FIG. 12 is a diagram depicting typical operations of the image combination section.

FIG. 13 is a diagram depicting typical operations of the image combination section.

### DESCRIPTION OF EMBODIMENTS

Preferred embodiments for implementing the present technology are described below. It is to be noted that the description will be given under the following headings:

1. Imaging system

2. Embodiments

2-1. Configuration of the imaging system

2-2. Operations of the imaging system

2-3. Typical operations of the imaging control section

2-4. Typical operations of the imaging control section

2-5. Operations to generate the display image

2-6. Other operations to generate the display image

3. Other Embodiments

4. Application examples

### 1. IMAGING SYSTEM

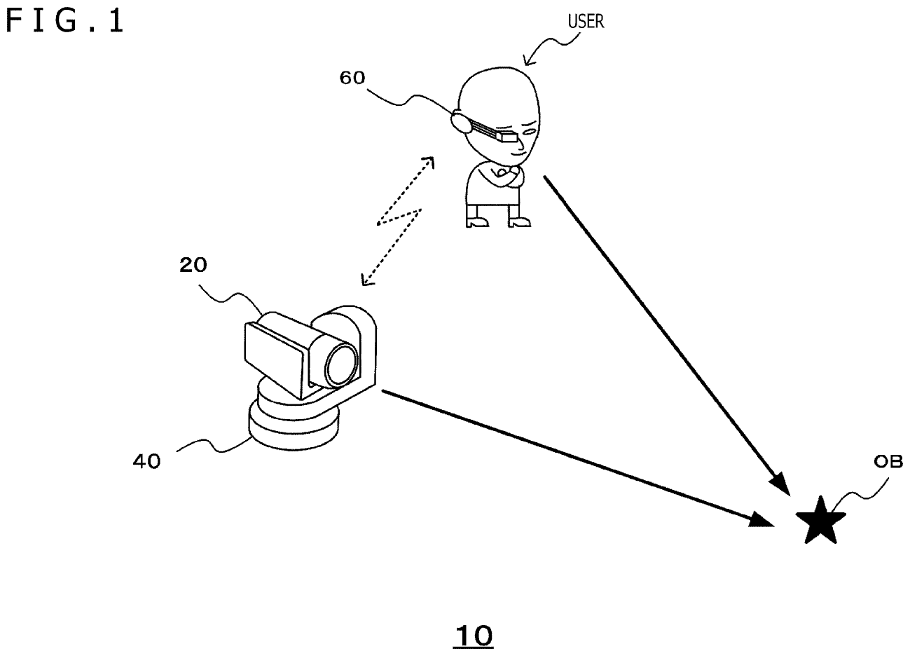

FIG. 1 depicts a configuration of an imaging system that uses an image processing apparatus and imaging apparatuses according to the present technology.

An imaging system 10 includes a main imaging apparatus 20, a camera platform 40, and a sub imaging apparatus 60. The main imaging apparatus 20 is secured to the camera platform 40, for example, such that the imaging direction can be changed by means of the camera platform 40. Further, the main imaging apparatus 20 and the sub imaging apparatus 60 are configured to communicate with each other via a wired or wireless transmission path. The sub imaging apparatus 60 is equipped with an image processing apparatus of the present technology. The sub imaging apparatus 60 is configured to be worn on a user's head, for example.

The sub imaging apparatus 60 remotely controls the main imaging apparatus 20, or both the main imaging apparatus 20 and the camera platform 40. In so doing, the sub imaging apparatus 60 enables the main imaging apparatus 20 to image a subject that interests the user from afar as an imaging target (the subject is also referred to as the “subject of interest”). The main imaging apparatus 20 or the sub imaging apparatus 60 generates a direction control signal based on relative positional relations between the main imaging apparatus 20 and the sub imaging apparatus 60 and on subject position information generated by the sub imaging apparatus 60, the generated direction control signal being output to the camera platform 40. On the basis of the direction control signal, the camera platform 40 moves the main imaging apparatus 20 in such a manner that the main imaging apparatus 20 can image a subject of interest OB.

Further, the sub imaging apparatus 60 has an imaging section with an angle of view different from that of the main imaging apparatus 20. The sub imaging apparatus 60 combines an image of the subject of interest generated by the main imaging apparatus 20 with an image of the subject of interest generated by the imaging section of the sub imaging apparatus 60, thereby generating a display image.

### 2. EMBODIMENTS

Some preferred embodiments of this technology are explained below. With these embodiments, the sub imaging apparatus 60 is configured to be worn on the user's head.

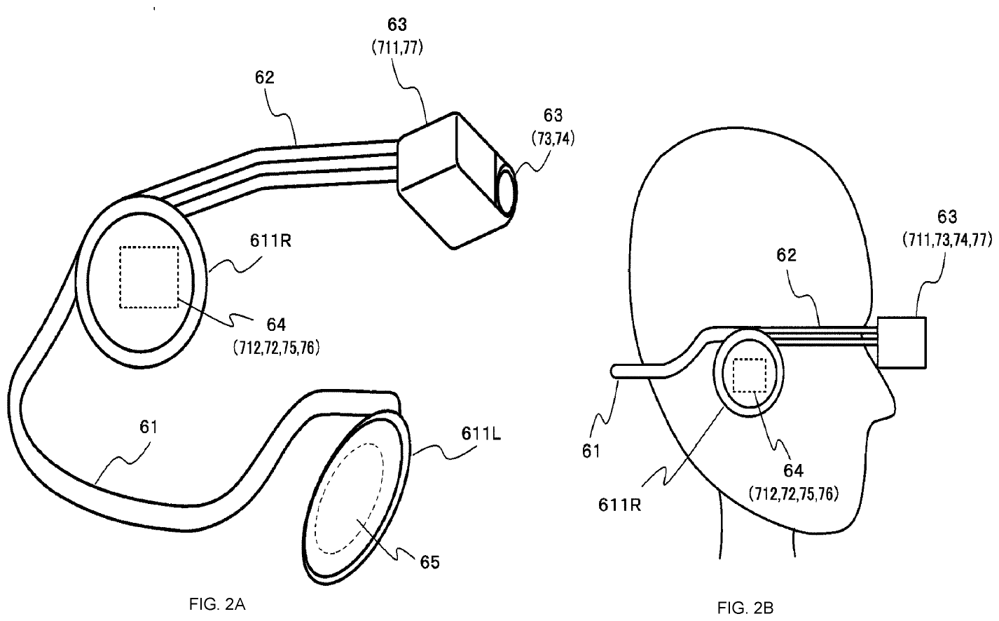

FIG. 2 illustrates the sub imaging apparatus. Subfigure (a) in FIG. 2 depicts an appearance of the sub imaging apparatus, and Subfigure (b) in FIG. 2 indicates a use state of the sub imaging apparatus. The sub imaging apparatus 60 includes a hold section 61, an arm section 62, an eyepiece block 63, a circuit block 64, and a power supply section 65.

When the sub imaging apparatus 60 is worn on the user's head, the hold section 61 secures the sub imaging apparatus 60 to the head. When viewed from above, for example, the hold section 61 is configured with a U-shaped neck band 610 and ear pads 611L and 611R attached to the tips of the neck band 610. With its curved portion in contact with the back of the user's head (or the neck), the hold section 61 has the ear pads 611L and 611R sandwiching the head or hooked on the ears. In such a manner, the hold section 61 is retained in an appropriate position relative to the user's head.

At one end of the hold section 61 is an arm section 62 extending forward. At the tip of the arm section 62 is the eyepiece block 63.

The eyepiece block 63 includes a display section 77 that acts as an electronic viewfinder. The eyepiece block 63 also includes an imaging optical system block 73 and an imaging section 74 for imaging what appears straight in front of the user. The eyepiece block 63 further includes a distance measurement section 711 that measures the distance to the subject of interest imaged by the imaging section 74, i.e., the distance to the subject of interest positioned straight in front of the user. The eyepiece block 63 may include a detection section for detecting a motion of viewing the display image on the display section 77, such as an eyepiece detection section that detects whether the user is looking into the eyepiece block 63. Given the result of the detection, the eyepiece detection section may perform display control to perform image combination, to be discussed later, in response to the detected motion to view the display image.

The ear pad 611R on one side includes the circuit block 64. The circuit block 64 includes a motion sensor section 712, a communication section 72, a parallax calculation section 75, and an image combination section 76. The ear pad 611L on the other side includes the power supply section 65. The motion sensor section 712 is configured using a nine-axis sensor that detects acceleration on three axes, angular velocity on three axes, and geomagnetism (azimuth direction) on three axes. Thus, the motion sensor section 712 generates motion information indicative of the amounts of position and posture changes of the sub imaging apparatus 60. The parallax calculation section 75 calculates a parallax between an imaging section 22 of the main imaging apparatus 20 and the imaging section 74 of the sub imaging apparatus 60. The image combination section 76 generates the display image by combining a captured image generated by the imaging section 74 with a captured image received by the communication section 72. Also, the image combination section 76 switches the image combining operation according to the parallax calculated by the parallax calculation section 75. Further, the image combination section 76 may generate the display image by combining images upon detection of a motion to view the display image.

The communication section 72 transmits to the main imaging apparatus 20 subject position information including the distance to the subject of interest OB measured by the distance measurement section 711 and the motion information generated by the motion sensor section 712. Also, the communication section 72 receives an image signal from the main imaging apparatus 20 and outputs the received image signal to the image combination section 76. The power supply section 65 supplies power to the communication section 72, the imaging section 74, the parallax calculation section 75, the image combination section 76, the display section 77, the distance measurement section 711, and the motion sensor section 712. Incidentally, the layout of the power supply section 65, the motion sensor section 712, the communication section 72, the parallax calculation section 75, and the image combination section 76 illustrated in FIG. 2 is only an example; these sections may be positioned in different ways.

### <2-1. Configuration of the Imaging System>

The configuration of the imaging system is explained next. In the imaging system 10, the position of the main imaging apparatus 20 is fixed. The camera platform 40 allows the imaging direction of the main imaging apparatus 20 to move in a pan direction and in a tilt direction. Further, the position of the sub imaging apparatus 60 is movable.

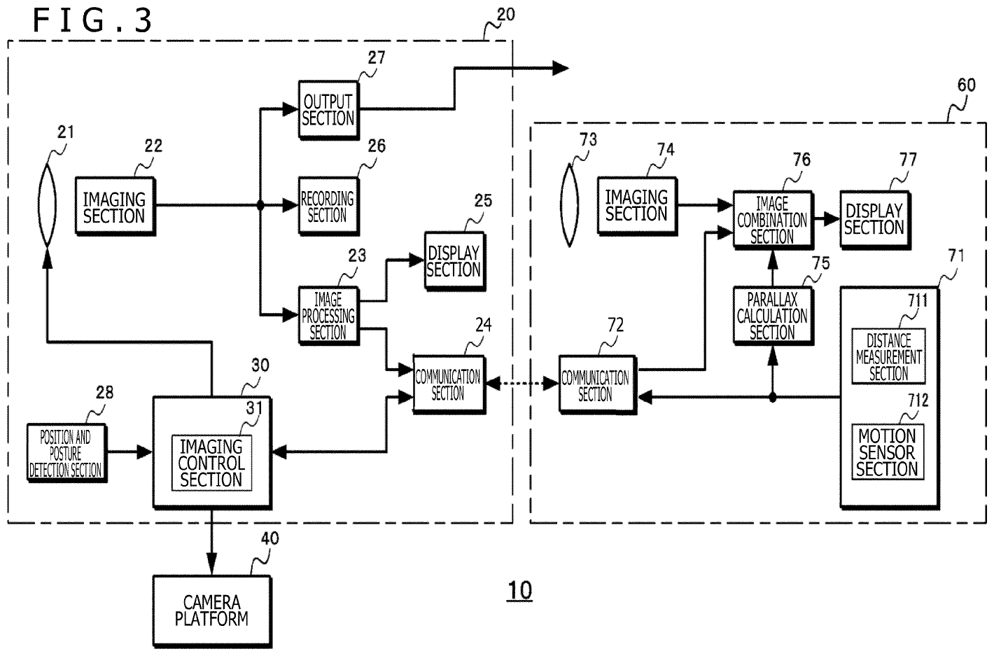

FIG. 3 depicts a typical configuration of the imaging system. The main imaging apparatus 20 includes an imaging optical system block 21, an imaging section 22, an image processing section 23, a communication section 24, a position and posture detection section 28, and a control section 30. The main imaging apparatus 20 may also include a display section 25, a recording section 26, and an output section 27.

The imaging optical system block 21, configured by use of a focus lens, forms an optical image of the subject on an imaging plane of the imaging section 22. The imaging optical system block 21 may also include a zoom lens and an iris mechanism.

The imaging section 22 has an imaging element such as a CMOS (Complementary Metal Oxide Semiconductor) or a CCD (Charge Coupled Device) and a signal processing section. The imaging element performs photoelectric conversion to generate an image signal corresponding to the optical image of the subject. The signal processing section performs processes such as noise removal, gain adjustment, analog/digital conversion, defective pixel correction, and image development on the pixel signal generated by the imaging element. The imaging section outputs the generated image signal to the image processing section 23. Also, the imaging section 22 outputs the generated image signal to the recording section 26 and to the output section 27.

The image processing section 23 converts the image signal supplied from the imaging section 22 into an image signal corresponding to the display resolution of the display section 77 in the sub imaging apparatus 60. The image processing section 23 outputs the converted image signal to the communication section 24. The image processing section 23 further converts the image signal supplied from the imaging section 22 into an image signal corresponding to the display resolution of the display section 25, and outputs the converted image signal to the display section 25.

The position and posture detection section 28 detects the posture or the posture and position, posture change, and position change of the main imaging apparatus 20. The position and posture detection section 28 outputs the result of the position and posture detection to the control section 30.

The communication section 24 communicating with the sub imaging apparatus 60 transmits the image signal supplied from the image processing section 23 to the sub imaging apparatus 60. The communication section 24 further receives the subject position information sent from the sub imaging apparatus 60, and outputs the received information to the control section 30.

The display section 25 is configured using a liquid crystal display element or an organic EL display element, for example. On the basis of the image signal supplied from the image processing section 23, the display section 25 displays the captured image generated by the main imaging apparatus 20. The display section 25 further displays menus of the main imaging apparatus 20 on the basis of control signals from the control section 30.

The recording section 26 is configured using recording media fixed to the main imaging apparatus 20, or removable recording media. On the basis of control signals from the control section 30, the recording section 26 records the image signal generated by the imaging section 22 to the recording media. Also, on the basis of the control signals from the control section 30, the output section 27 outputs the image signal generated by the imaging section 22 to an external device.

The control section 30 has a CPU (Central Processing Unit), a ROM (Read Only Memory), and a RAM (Random Access Memory). The ROM stores various programs to be executed by the CPU. The RAM stores information such as diverse parameters. The CPU executes the various programs stored in the ROM, thereby controlling the components involved in such a manner that the main imaging apparatus 20 performs operations corresponding to manipulations made by the user. The control section 30 further includes an imaging control section 31 that performs control to make the main imaging apparatus 20 image the subject of interest OB, on the basis of the subject position information supplied from the sub imaging apparatus 60.

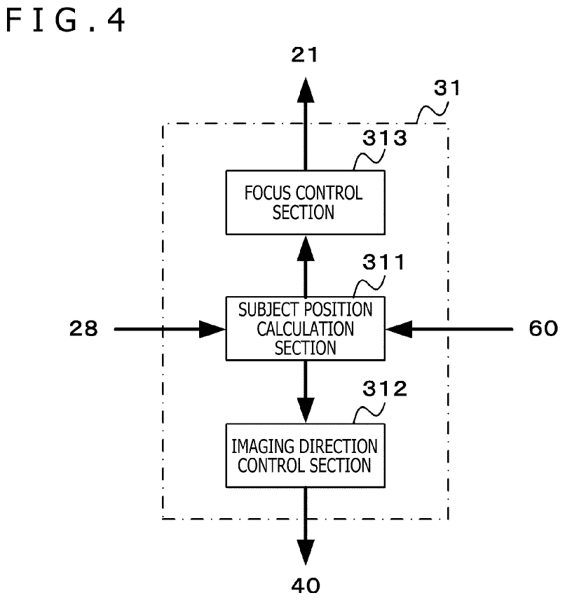

FIG. 4 depicts a typical functional configuration of the imaging control section. The imaging control section 31 includes a subject position calculation section 311, an imaging direction control section 312, and a focus control section 313. Incidentally, in a case where the depth of field of the main imaging apparatus 20 is so large that focus adjustment is not necessary, the imaging control section 31 may dispense with the focus control section 313.

The subject position calculation section 311 calculates the direction of, and the distance to, the subject of interest based on the result of the position and posture detection by the position and posture detection section 28 and on the subject position information supplied from the sub imaging apparatus 60. Incidentally, how to calculate the direction of and the distance to the subject of interest will be discussed later in detail. The subject position calculation section 311 outputs the result of calculating the direction of the subject of interest to the imaging direction control section 312, and outputs the result of calculating the distance to the subject of interest to the focus control section 313.

On the basis of the result of calculating the direction of the subject of interest, the imaging direction control section 312 generates a direction control signal such that the imaging direction of the main imaging apparatus 20 is set to the direction of the subject of interest. The imaging direction control section 312 outputs the generated direction control signal to the camera platform 40. On the basis of the result of calculating the distance to the subject of interest, the focus control section 313 generates a focus control signal such that the focus position of the main imaging apparatus 20 is set to the position of the subject of interest. The focus control section 313 outputs the generated focus control signal to the imaging optical system block 21.

Returning to FIG. 3, the configuration of the sub imaging apparatus 60 is explained. The sub imaging apparatus 60 includes a subject position information generation section 71, the communication section 72, the imaging optical system block 73, the imaging section 74, the parallax calculation section 75, the image combination section 76, and the display section 77. The subject position information generation section 71 includes a distance measurement section 711 and a motion sensor section 712.

As described above, the distance measurement section 711 measures the distance to the subject of interest positioned straight in front of the user wearing the sub imaging apparatus 60. The motion sensor section 712 generates the motion information indicative of the amounts of position and posture changes of the sub imaging apparatus 60. The subject position information generation section 71 generates the subject position information including the distance to the subject of interest measured by the distance measurement section 711 and the motion information generated by the motion sensor section 712, then outputs the subject position information to the communication section 72.

The communication section 72 transmits to the main imaging apparatus 20 the subject position information generated by the subject position information generation section 71. Further, the communication section 72 receives the image signal sent from the main imaging apparatus 20 and outputs the received image signal to the image combination section 76.

The imaging optical system block 73, configured by use of a focus lens, forms an optical image of the subject on an imaging plane of the imaging section 74. The imaging optical system block 73 may include a zoom lens.

The imaging section 74 has an imaging element such as a CMOS (Complementary Metal Oxide Semiconductor) or a CCD (Charge Coupled Device) and a signal processing section. The imaging element performs photoelectric conversion to generate an image signal corresponding to the optical image of the subject. The signal processing section performs processes such as noise removal, gain adjustment, analog/digital conversion, defective pixel correction, and image development on the pixel signal generated by the imaging element. The imaging section outputs the generated image signal to the image combination section 76.

The parallax calculation section 75 calculates the parallax between the imaging section 74 and the imaging section 22 in the main imaging apparatus 20, on the basis of the subject position information generated by the subject position information generation section 71. The parallax calculation section 75 outputs the calculated parallax to the image combination section 76.

The image combination section 76 generates a display signal by using the image signal generated by the imaging section 74 as well as the image signal received by the communication section 72 from the main imaging apparatus 20. The display signal is generated according to the parallax calculated by the parallax calculation section 75, as will be discussed later. Further, the image combination section 76 outputs the generated display signal to the display section.

The display section 77 is configured using a liquid crystal display element or an organic EL display element, for example. The display section 77 displays the captured image based on the display signal generated by the image combination section 76.

### <2-2. Operations of the Imaging System>

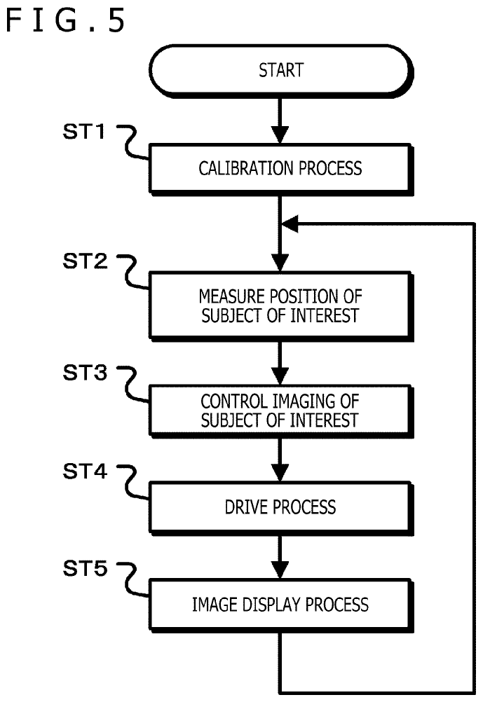

FIG. 5 is a flowchart depicting typical operations of the imaging system. In step ST1, the imaging system 10 performs a calibration process. Using the state in which the main imaging apparatus 20 and the sub imaging apparatus 60 face each other as an initial state, the imaging system 10 causes the sub imaging apparatus 60, for example, to calculate the distance to the main imaging apparatus 20 and considers the calculated distance to be a reference distance. Further, the main imaging apparatus 20 regards the direction of the sub imaging apparatus 60 as a reference direction, and the sub imaging apparatus 60 regards the direction of the main imaging apparatus 20 as a reference direction. Step ST2 is then reached.

In step ST2, the sub imaging apparatus measures the position of the subject of interest. Following the calibration process, the user changes his or her posture in such a manner that the subject of interest appears straight in front of the user. The sub imaging apparatus 60 then causes the distance measurement section 711 to measure the distance to the subject of interest positioned straight in front, and causes the motion sensor section 712 to generate motion information indicative of a motion in the direction of the subject of interest with respect to the reference direction (i.e., the motion is given as an angle representing the posture change). In a case where the user moves, the motion sensor section 712 in the sub imaging apparatus 60 generates motion information indicative of the distance and direction of the user's motion. The sub imaging apparatus 60 transmits the subject position information including the measured distance and the motion information to the main imaging apparatus 20. Step ST3 is then reached.

In step ST3, the imaging control section of the main imaging apparatus performs imaging control on the subject of interest. On the basis of the subject position information supplied from the sub imaging apparatus 60, the imaging control section 31 calculates the direction of, and the distance to, the subject of interest with respect to the main imaging apparatus 20. The imaging control section 31 further generates a direction control signal based on the direction of the subject of interest, and generates a focus control signal based on the distance to the subject of interest. Step ST4 is then reached.

In step ST4, the camera platform and the main imaging apparatus perform a drive process. The camera platform 40 moves the imaging direction of the main imaging apparatus 20 in the direction of the subject of interest, on the basis of the direction control signal generated in step ST3. The main imaging apparatus 20 drives the imaging optical system block 21 based on the focus control signal generated in step ST3 for focus adjustment such that the focus position is set to the position of the subject of interest. Step ST5 is then reached. It is to be noted that, in a case where the depth of field of the main imaging apparatus 20 is large, focus adjustment may not be necessary.

In step ST5, the sub imaging apparatus performs an image display process. The image combination section of the sub imaging apparatus 60 combines, for example, a captured image generated by the sub imaging apparatus 60 with a captured image generated by the main imaging apparatus 20, thereby generating an image signal representing the display image and outputting the generated image signal to the display section 77. Step ST2 is then reached again.

### <2-3. Typical Operations of the Imaging Control Section>

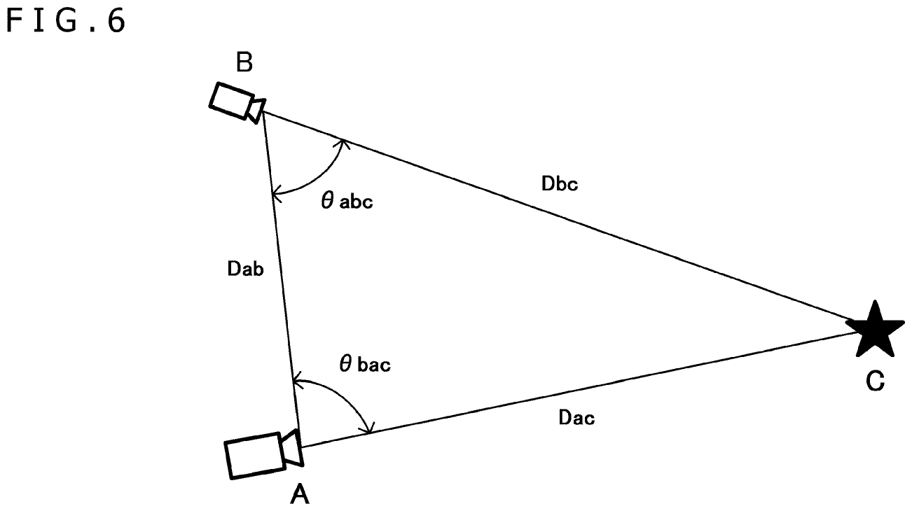

Typical operations of the imaging control section are explained next. FIG. 6 is a diagram for explaining operations of the subject position calculation section in the imaging control section. In FIG. 6, reference sign “A” denotes the position of the main imaging apparatus 20 mounted on the camera platform 40, “B” represents the position of the sub imaging apparatus 60, and “C” stands for the position of the subject of interest.

In the imaging system 10, the main imaging apparatus 20 and the sub imaging apparatus 60 are made to face each other for calibration. The postures of the main imaging apparatus 20 and of the sub imaging apparatus 60 at this point are assumed to constitute the initial state. The sub imaging apparatus 60 measures a distance Dab to the main imaging apparatus 20 in the initial state, and transmits the measured distance Dab to the main imaging apparatus 20.

Thereafter, the user wearing the sub imaging apparatus 60 turns away from the main imaging apparatus 20 to the subject of interest. The distance measurement section 711 in the sub imaging apparatus 60 then measures a distance Dbc from the position B to the position C. The motion sensor section 712 measures an angle θabc in the direction of the position C with respect to the reference direction (direction of the position A). The sub imaging apparatus transmits the distance Dbc and the angle θabc as the subject position information to the main imaging apparatus 20.

The subject position calculation section 311 in the main imaging apparatus 20 calculates a distance Dac from the position A of the main imaging apparatus to the position C of the subject in accordance with the following mathematical formula (1):

[Math. 1]

D_{ac}=\sqrt{D_{ab}²+D_{bc}²−2*D_{ab}*D_{bc}*cos θ_{abc}} (1)

Also, the subject position calculation section 311 calculates an angle θbac of the main imaging apparatus 20 in the direction of the position C with respect to the reference direction (direction of the position B) in accordance with the following mathematical formula (2):

$$\begin{matrix}[ Math . 2 ] & \\ cos {θ}_{b a c} = \frac{{D}_{ab}^{2} + {D}_{a c}^{2} - {D}_{b c}^{2}}{2 * {D}_{a b} * {D}_{a c}} & ( 2 )\end{matrix}$$

The subject position calculation section 311 outputs the calculated angle θbac to the imaging direction control section 312. This allows the imaging direction control section 312 to generate a direction control signal for setting the imaging direction of the main imaging apparatus 20 to a direction of the angle θbac with respect to the reference direction (direction of the position B), the generated direction control signal being output to the camera platform 40. As a result, the imaging direction of the main imaging apparatus 20 is set to the direction of the subject of interest.

The subject position calculation section 311 outputs the calculated distance Dac to the focus control section 313. This allows the focus control section 313 to generate a focus control signal for setting the focus position of the main imaging apparatus 20 to the distance Dac, the generated focus control signal being output to the imaging optical system block 21. As a result, the main imaging apparatus 20 is focused on the subject of interest.

When the user changes his or her posture to follow the subject of interest, the sub imaging apparatus 60 generates new subject position information indicative of the distance to the subject of interest and of the motion to follow the subject of interest, the newly generated subject position information being transmitted to the main imaging apparatus 20. As a result, the main imaging apparatus 20 performs imaging direction control and focus control based on the new subject position information in such a manner that the imaging direction and the focus position follow the subject of interest. This enables continuous acquisition of captured images focused on the subject of interest.

Further, the captured image acquired by the main imaging apparatus 20 is displayed on the display section 77 of the sub imaging apparatus 60. This makes it possible to verify whether the imaging operation is being performed in a manner focused on the subject of interest.

### <2-4. Other Typical Operations of the Imaging Control Section>

A case in which not only the subject of interest but also the position of the user is moved is explained below in terms of other operations of the imaging control section.

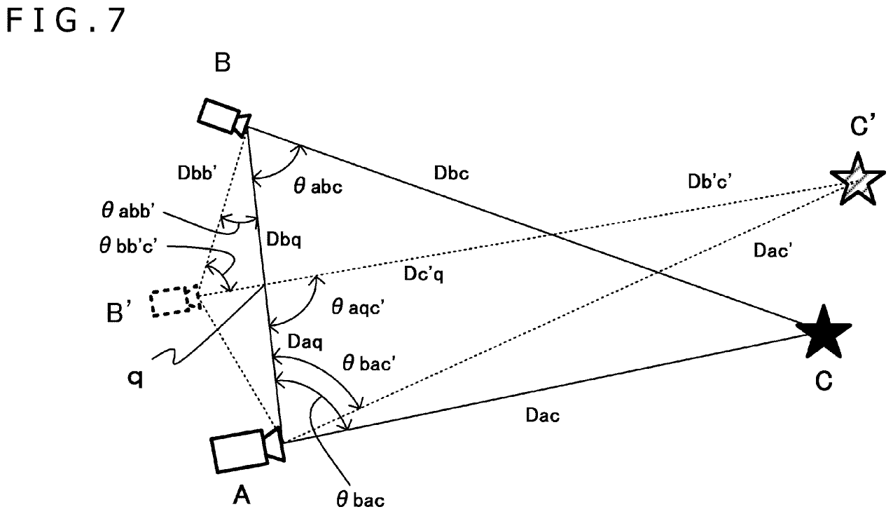

FIG. 7 is a diagram for explaining other operations of the subject position calculation section in the imaging control section. In FIG. 7, reference sign “A” denotes the position of the main imaging apparatus 20 mounted on the camera platform 40, “B” represents the position of the sub imaging apparatus 60, “C” stands for the position of the subject of interest, “B′” denotes the position of the sub imaging apparatus 60 following the motion, and “C′” represents the position of the subject of interest following the motion. Further, reference sign “q” stands for the point of intersection between a straight line connecting the position A with the position B on one hand and a straight line connecting the position B′ with the position C′ on the other hand.

In the imaging system 10, the main imaging apparatus 20 and the sub imaging apparatus 60 are made to face each other for calibration. The postures of the main imaging apparatus 20 and of the sub imaging apparatus 60 at this point are assumed to constitute the initial state. The sub imaging apparatus 60 measures the distance Dab to the main imaging apparatus 20 in the initial state, and transmits the measured distance Dab to the main imaging apparatus 20.

Thereafter, the user wearing the sub imaging apparatus 60 turns away from the main imaging apparatus 20 to face the subject of interest. The distance measurement section 711 in the sub imaging apparatus 60 then measures the distance Dbc from the position B to the position C. The motion sensor section 712 measures the angle θabc in the direction of the position C with respect to the reference direction (direction of the position A). The sub imaging apparatus transmits the distance Dbc and the angle θabc as the subject position information to the main imaging apparatus 20.

The subject position calculation section 311 in the main imaging apparatus 20 calculates the distance Dac from the position A of the main imaging apparatus to the position C of the subject in accordance with the mathematical formula (1) given above.

In the case where the user wearing the sub imaging apparatus 60 moves from the position B to a position B′, the motion sensor section 712 in the sub imaging apparatus 60 measures a distance Dbb′ from the position B to the position B′ and an angle θaqc′. The distance measurement section 711 in the sub imaging apparatus 60 measures a distance Db′c′ from the position B′ to the position C′ of the subject following the motion. The sub imaging apparatus 60 transmits the results of measuring the distance Dbb′, the distance Db′c′, and the angle θaqc′ as the subject position information to the main imaging apparatus 20.

The subject position calculation section 311 in the main imaging apparatus 20 calculates a distance Db′a based on the distance Dab and the distance Dbb′. Further, in accordance with the following mathematical formula (3), the subject position calculation section 311 calculates an angle θabb′ in the direction of the position B′ following the motion with respect to the reference direction (direction of the position A) at the time when the sub imaging apparatus 60 is in the position B:

$$\begin{matrix}[ Math . 3 ] & \\ cos {θ}_{abb ′} = \frac{{D}_{ab}^{2} + {D}_{{bb}^{′}}^{2} - {D}_{{ab}^{′}}^{2}}{2 * {D}_{ab} * {D}_{{bb}^{′}}} & ( 3 )\end{matrix}$$

Further, in accordance with the mathematical formula (4) given below, the subject position calculation section 311 calculates a distance Dbq from the reference direction (direction of the position B) for the main imaging apparatus 20 to the point of intersection q. It is to be noted that an angle θbb′c′ is calculated on the basis of the angle θabB′ and the angle θaqc′.

[Math. 4]

D_{bq}=\sqrt{D_{bb′}²+D_{b′q}²−2*D_{bb′}*D_{b′q}*cos θ_{bb′q}} (4)

The subject position calculation section 311 calculates a distance Dqa by subtracting the distance Dbq from the distance Dab. Also, the subject position calculation section 311 calculates a distance Db′q based on the distance Dbb′ and on the angles θabb′ and θbb′q. The subject position calculation section 311 then calculates a distance Dc′q by subtracting the calculated distance Db′q from the distance Db′c′. Further, the subject position calculation section 311 calculates a distance Dac′ in accordance with the following mathematical formula (5):

[Math. 5]

D_{ac′}=\sqrt{D_{c′q}²+D_{qa}²−2*D_{c′q}*D_{qa}*cos θ_{aqc′}} (5)

Also, the subject position calculation section 311 calculates an angle θbac′ in the direction of position C′ with respect to the reference direction of the main imaging apparatus (direction of the position B) in accordance with the following mathematical formula (6).

$$\begin{matrix}[ Math . 6 ] & \\ cos {θ}_{{bac}^{′}} = \frac{{D}_{a q}^{2} + {D}_{a {c}^{′}}^{2} - {D}_{{c}^{′} q}^{2}}{2 * {D}_{a q} * {D}_{{ac}^{′}}} & ( 6 )\end{matrix}$$

The subject position calculation section 311 outputs the calculated angle θbac′ to the imaging direction control section 312. This causes the imaging direction control section 312 to generate a direction control signal for setting the imaging direction of the main imaging apparatus 20 to the direction of the angle θbac′ with respect to the reference direction of the main imaging apparatus 20 (direction of the position B), the generated direction control signal being output to the camera platform 40. As a result, the imaging direction of the main imaging apparatus 20 is set to the direction of the subject of interest following the motion.

Also, the subject position calculation section 311 outputs the calculated distance Dac′ to the focus control section 313. This causes the focus control section 313 to generate a focus control signal for setting the focus position of the main imaging apparatus 20 to the distance Dac′, the generated focus control signal being output to the imaging optical system block 21. As a result, the main imaging apparatus 20 is focused on the subject of interest following the motion.

When the user changes his or her posture and position to follow the subject of interest, the sub imaging apparatus 60 generates new subject position information indicative of the distance to the subject of interest and of the motion to follow the subject of interest, the newly generated subject position information being transmitted to the main imaging apparatus 20. As a result, the main imaging apparatus 20 performs imaging direction control and focus control based on the new subject position information in such a manner that the imaging direction and the focus position follow the subject of interest when the user moves. This enables continuous acquisition of captured images focused on the subject of interest.

The position of the main imaging apparatus need not be fixed and can be moved. In this case, the angle indicative of the direction of the subject of interest and the distance to the subject of interest are calculated in reference to the direction at the time when the main imaging apparatus is in the initial state. Further, the angle indicative of the direction of the subject of interest and the distance to the subject of interest may, when calculated, be corrected according to the moving direction of the main imaging apparatus and the amount of its motion.

### <2-5. Operations to Generate the Display Image>

The sub imaging apparatus 60 combines a sub captured image generated by the imaging section 74 with a main captured image generated by the main imaging apparatus 20 with an angle of view different from that of the sub captured image. It is to be noted that the main captured image is a captured image generated by the main imaging apparatus 20 of which the imaging direction is controlled to be in the direction of the subject imaged by the imaging section 74, on the basis of the subject position information supplied from the sub imaging apparatus 60 as discussed above.

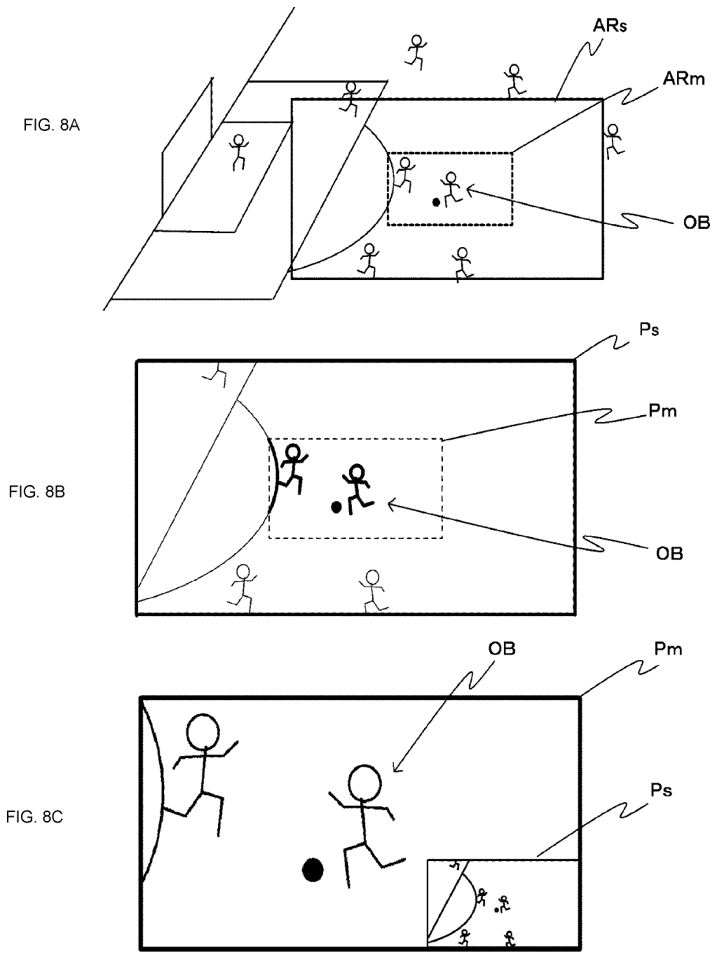

FIG. 8 depicts typical operations to generate a display image. In Subfigure (a) in FIG. 8, an area ARs denotes the imaging range of the sub imaging apparatus 60. At the center of the imaging range is the subject of interest OB. The main imaging apparatus 20 has its imaging direction controlled to image the subject of interest OB, on the basis of the subject position information supplied from the sub imaging apparatus 60. It is to be noted that an area ARm denotes the imaging range of the main imaging apparatus 20. The main imaging apparatus 20 has a higher scaling factor and a narrower angle of view than the sub imaging apparatus 60.

As depicted in Subfigure (b) in FIG. 8, the image combination section 76 in the sub imaging apparatus 60 generates the display image by superposing a main captured image Pm generated by the main imaging apparatus 20 on the central part of a sub captured image Ps generated by the imaging section 74, for example. In this case, even if the subject of interest OB deviates from the area ARm that is the imaging range of the main imaging apparatus 20, the position of the subject of interest OB can be recognized on the basis of the sub captured image Ps generated by the imaging section 74. As a result, it is easy for the main imaging apparatus 20 to follow and image the subject of interest OB when the user changes his or her posture in such a manner that the subject of interest OB appears straight in front. It is to be noted that that position in the sub captured image Ps on which to superpose the main captured image Pm is not limited to the central part of the sub captured image Ps. Alternatively, the main captured image Pm may be superposed on a position shifted by an appropriate amount from the central part of the sub captured image Ps.

The image combination section 76 may, as depicted in Subfigure (c) in FIG. 8, generate the display image by scaling down the sub captured image with a wide angle of view and by superposing the scaled-down image on the main captured image with a narrow angle of view. When generated in such a manner, the display image enables verification of the captured image generated by the main imaging apparatus 20 while allowing the scaled-down sub captured image to provide verification of the overall status.

Thus, according to the present technology, if the desired subject being imaged by the main imaging apparatus 20 deviates from the imaging range, the user need only change his or her posture to face the subject by using the sub captured image generated by the imaging section 74 in the sub imaging apparatus 60, so as to let the main imaging apparatus 20 image the subject continuously. The display section 77 of the sub imaging apparatus 60, by displaying the main captured image generated by the main imaging apparatus 20, permits verification of the operating state of the main imaging apparatus 20. Further, being different from a case where an attachment mounts on the imaging apparatus as described in PTL 1, because the sub imaging apparatus 60 need not be integral with the main imaging apparatus 20, there are no such irregularities as vignetting in images generated by an attachment of the imaging lens mounted on the imaging apparatus.

In a case where the sub imaging apparatus 60 is made to function as a viewfinder, with the main imaging apparatus 20 generating a main captured image with higher image quality than a sub captured image generated by the sub imaging apparatus 60 and with the sub imaging apparatus 60 made smaller in size and lighter in weight than the main imaging apparatus 20, there may be provided a highly usable imaging system that can record or output high-quality captured images.

### <2-6. Other Operations to Generate the Display Image>

Incidentally, in a case where the distance from the main imaging apparatus 20 to the sub imaging apparatus 60 is short, the parallax therebetween is small and thus affects the display image very little. Where the parallax is large, however, it becomes apparent that the display image is a combination of images from different points of view. Thus, in another display operation, the operation of the image combination section 76 is switched to generate a display image with a minimum of effects from parallax.

What follows is an explanation of the display operation in the case where the display image is switched depending on parallax. In this case, the parallax calculation section 75 calculates the parallax at the time when the subject of interest is imaged by both the sub imaging apparatus 60 and the main imaging apparatus 20, on the basis of the distance from the sub imaging apparatus 60 to the subject of interest and of the initial state of the sub imaging apparatus 60 and the main imaging apparatus 20.

The parallax calculation section 75 calculates the angles θabc and θbac in a similar manner to the above-mentioned imaging control section 31. From the sum of the interior angles of a triangle (ABC), the parallax calculation section 75 subtracts the angles θabc and θba to calculate an angle θacb indicative of the parallax. In a case where the user and the subject move, an angle θac′b′ is only required to be calculated using the angles θaqc′ and θbac′, for example. In the ensuing description, reference sign “θp” denotes the parallax of the subject of interest.

The parallax calculation section 75 outputs the calculated parallax θp to the image combination section 76. The image combination section 76 switches image combination operation depending on the result of comparison between the parallax θp (=θacb, θac′b′) calculated by the parallax calculation section 75 on one hand and a predetermined first threshold value on the other hand, or between the parallax θp on one hand and the first threshold value as well as a second threshold value larger than the first threshold value on the other hand.

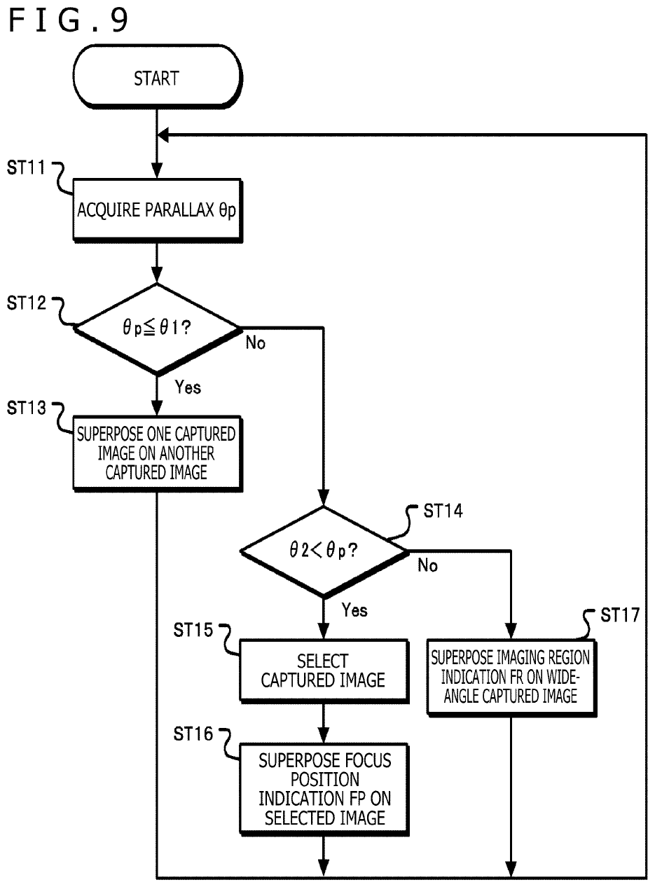

FIG. 9 is a flowchart depicting typical image combination operations. In step ST11, the image combination section acquires the parallax θp. The image combination section 76 acquires the parallax θp calculated by the parallax calculation section 75, before proceeding to step ST12.

In step ST12, the image combination section determines whether the parallax θp is equal to or smaller than the first threshold value θ1. The first threshold value θ1 is set beforehand as a maximum parallax of which the effects are negligible on the main captured image Pm generated by the main imaging apparatus 20 and on the sub captured image Ps generated by the imaging section 74 in the sub imaging apparatus 60. In a case where the parallax θp is equal to or smaller than the predetermined first threshold value θ1, the image combination section 76 proceeds to step ST13. In a case where the parallax θp is larger than the first threshold value θ1, the image combination section 76 proceeds to step ST14.

In step ST13, the image combination section superposes one captured image on another captured image. The image combination section 76 combines the main captured image Pm with the sub captured image Ps having an angle of view different from that of the main captured image Pm, as explained above with reference to FIG. 8. For example, the image combination section 76 generates the display image by superposing the main captured image Pm generated by the main imaging apparatus 20 on the sub captured image Ps generated by the imaging section 74, and returns to step ST11.

In step ST14, the image combination section determines whether the parallax θp is larger than the second threshold value θ2. The second threshold value θ2 (>θ1) is set beforehand as a minimum parallax large enough to disable the effective use of an identification indication. In a case where the parallax θp is larger than the predetermined second threshold value θ2, the image combination section 76 proceeds to step ST15. In a case where the parallax θp is equal to or smaller than the predetermined second threshold value θ2, the image combination section 76 proceeds to step ST17.

In step ST15, the image combination section selects one captured image. The image combination section 76 selects either the main captured image Pm or the sub captured image Ps. For example, the image combination section 76 selects the sub captured image Ps with the wider angle of view, and proceeds to step ST16.

In step ST16, the image combination section superposes a focus position indication FP on the selected image. The image combination section 76 generates the display image by placing on the captured image selected in step ST15 the focus position indication FP indicative of the focus position of the unselected captured image. For example, the image combination section 76 generates the display image by superposing on the sub captured image the focus position indication FP indicative of the focus position of the main imaging apparatus. The image combination section 76 then returns to step ST11.

In step ST17, the image combination section superposes an imaging region indication FR on a wide-angle captured image. The image combination section 76 generates the display image by superposing on the wide-angle captured image the imaging region indication FR indicative of the imaging region of the other captured image, e.g., by superposing on the sub captured image Ps the imaging region indication FR indicative of the imaging range of the main imaging apparatus 20. The image combination section 76 then returns to step ST11.

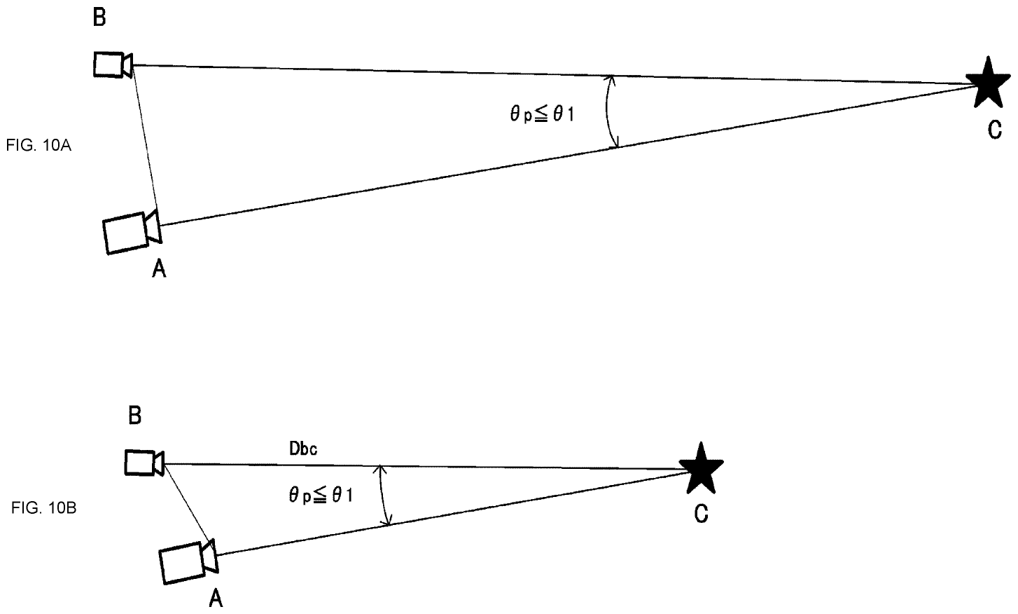

FIGS. 10 through 13 depict typical operations of the image combination section. It is assumed that the sub captured image Ps generated by the sub imaging apparatus 60 has a wider angle of view than the main captured image generated by the main imaging apparatus 20.

As depicted in Subfigure (a) in FIG. 10, where the position C of the subject of interest is away from the position A of the main imaging apparatus 20 and from the position B of the sub imaging apparatus 60 such that the parallax θp is equal to or smaller than the first threshold value θ1, the image combination section 76 generates the display image by superposing the main captured image Pm on the sub captured image Ps. As depicted in Subfigure (b) in FIG. 10, where the distance from the position C to the position A or B is short but where the main imaging apparatus 20 and the sub imaging apparatus 60 are close to each other (i.e., the positional difference in the circumferential direction from the viewpoint of the position C is small), the parallax θp is also equal to or smaller than the first threshold value θ1. In this case, too, the image combination section 76 generates the display image by superposing the main captured image Pm on the sub captured image Ps.

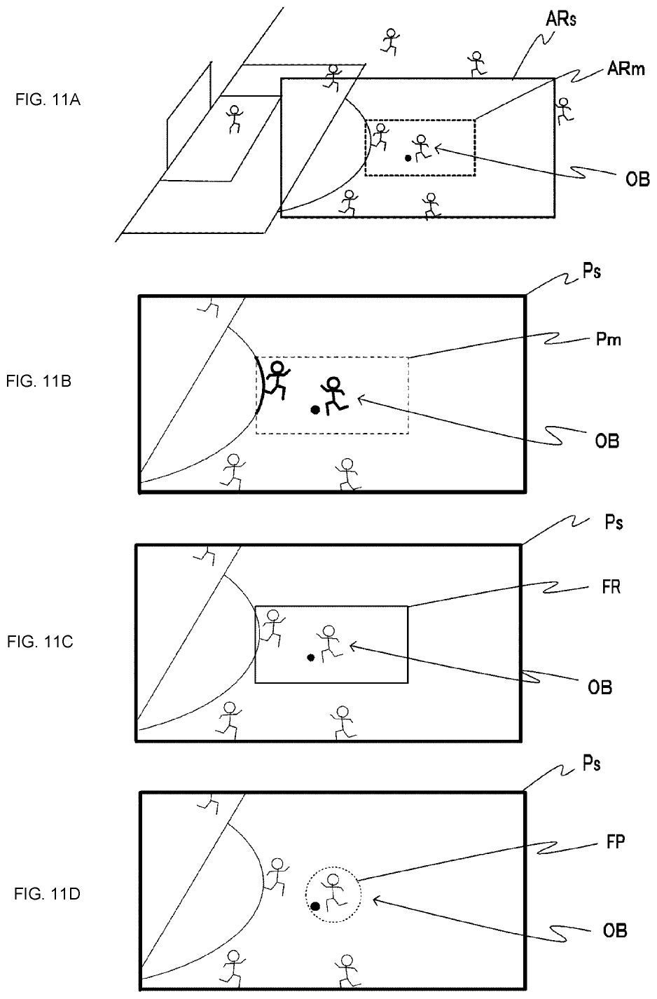

FIG. 11 depicts typical display images generated according to parallax. In Subfigure (a) in FIG. 11, an area ARs denotes the imaging range of the sub imaging apparatus 60. At the center of this imaging range is the subject of interest OB. The main imaging apparatus 20 has its imaging direction controlled to image the subject of interest OB, on the basis of the subject position information supplied from the sub imaging apparatus 60. An area ARm denotes the imaging range of the main imaging apparatus 20. The main imaging apparatus 20 has a higher scaling factor and a narrower angle of view than the sub imaging apparatus 60. Subfigure (b) in FIG. 11 illustrates a display image generated by superposing the main captured image Pm on the sub captured image Ps. In the case where the parallax θp is equal to or smaller than the first threshold value θ1, the display image is generated by superposing the main captured image Pm on the sub captured image Ps, so that not only the subject but also the surrounding status can be recognized. It is also possible to verify the main captured image recorded or output by the main imaging apparatus 20.

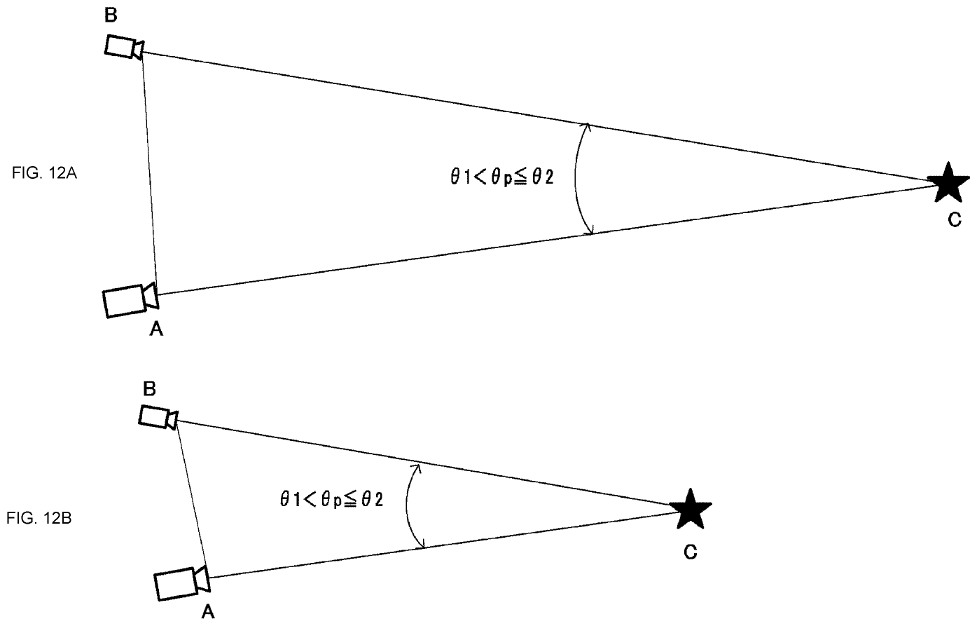

As depicted in Subfigure (a) in FIG. 12, where the position C of the subject of interest is away from the position A of the main imaging apparatus 20 and from the position B of the sub imaging apparatus 60 and where the positions A and B are also away from each other (i.e., the positional difference in the circumferential direction from the viewpoint of the subject is large) such that the parallax θp is larger than the first threshold value θ1 and is equal to or smaller than the second threshold value θ2, the image combination section 76 generates the display image by superposing an imaging region indication indicative of the imaging range of the main imaging apparatus 20 on the sub captured image Ps with a wide angle of view. Further, as depicted in Subfigure (b) in FIG. 12, where the distance from the position C to the position A or B is short and where the positions A and C are not close to each other (i.e., the positional difference in the circumferential direction from the viewpoint of the subject is not small) such that the parallax θp is larger than the first threshold value θ1 and is equal to or smaller than the second threshold value θ2, the image combination section 76 also generates the display image by superposing the imaging region indication indicative of the imaging region of the main imaging apparatus 20 on the sub captured image Ps with a wide angle of view. Subfigure (c) in FIG. 11 depicts a display image generated by superposing on the sub captured image Ps the imaging region indication FR indicative of the imaging region of the main imaging apparatus 20. In the case where the parallax θp is larger than the first threshold value θ1 and is equal to or smaller than the second threshold value θ2, the display image is generated by superposing the imaging region indication FR on the sub captured image Ps. This prevents the captured image with a wide angle of view from being superposed on the sub captured image Ps, thereby forestalling the possibility of the display image becoming uncomfortable to view. The imaging region indication FR further permits recognition of the region being imaged by the main imaging apparatus 20.

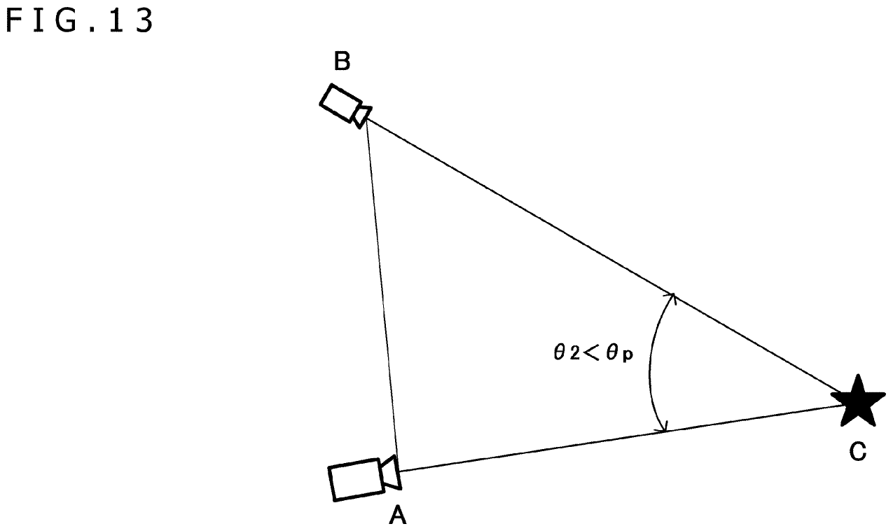

As depicted in FIG. 13, where the distance from the position C of the subject of interest to the position A of the main imaging apparatus 20 and to the position B of the sub imaging apparatus 60 is short and where the positions A and B are away from each other (i.e., the positional difference in the circumferential direction from the viewpoint of the subject is large) such that the parallax θp is larger than the second threshold value θ2, the image combination section 76 generates the display image by superposing, for example, on the sub captured image Ps a focus position indication FP indicative of the focus position of the main imaging apparatus 20. Subfigure (d) in FIG. 11 depicts a display image generated by superposing on the sub captured image Ps the focus position indication FP indicative of the focus position of the main imaging apparatus 20. In the case where the parallax θp is larger than the second threshold value θ2, the display image is generated by superposing the focus position indication FP on the sub captured image Ps. This prevents the captured image with a wide angle of view from being superposed on the sub captured image Ps, thereby forestalling the possibility of the display image becoming uncomfortable to view. Further, if a large parallax makes it difficult to display on the sub captured image Ps the region being imaged by the main imaging apparatus 20, the focus position indication FP permits recognition of which of the subjects is imaged by the main imaging apparatus 20.

Thus, according to the present technology, the display section of the sub imaging apparatus is caused to display an optimal display image according to the positional relation between the main imaging apparatus, the sub imaging apparatus, and the subject of interest.

### 3. OTHER EMBODIMENTS

Whereas in the above-described embodiments, angles are calculated by the imaging control section 31 in the main imaging apparatus 20 and by the parallax calculation section 75. Alternatively, either the imaging control section 31 or the parallax calculation section 75 may be used to perform the process of angle calculation. For example, the imaging control section 31 in the main imaging apparatus 20 may calculate the parallax θp and supply what is calculated to the image combination section 76 in the sub imaging apparatus 60. As another alternative, the parallax calculation section 75 in the sub imaging apparatus 60 may generate a direction control signal by calculating angles and output the generated direction control signal to the main imaging apparatus 20 or to the camera platform 40.

### 4. APPLICATION EXAMPLES

The technology according to the present disclosure may be applied to diverse products. For example, the technology of the present disclosure may be applied to a surgery system and a monitoring system.

The sub imaging apparatus depicted in FIG. 2 may be worn by the surgeon (doctor), with the main imaging apparatus arranged to image the surgical site. The sub imaging apparatus generates the captured image with an angle of view wider than that of the captured image generated by the main imaging apparatus. The camera platform allows the imaging direction of the main imaging apparatus to be moved at least within the range of the surgical site. When the sub imaging apparatus, the main imaging apparatus, and the camera platform are configured in such a manner, the main imaging apparatus can follow and image the affected area that interests the surgeon. Further, the eyepiece block of the sub imaging apparatus displays the captured image of a wide range covering the surgical site as well as the image of the surgical site. This enables the surgeon to operate on the site of interest based on the captured image generated by the main imaging apparatus while recognizing the overall status of the surgical site, on the basis of the captured image generated by the imaging section of the sub imaging apparatus. Alternatively, the sub imaging apparatus may image the surgical site while the main imaging apparatus may generate the captured image with an angle of view wider than that of the captured image by the sub imaging apparatus. In this case, the sub imaging apparatus may image the surgical site at high magnification while the main imaging apparatus may image a wider range covering the surgical site.

The sub imaging apparatus depicted in FIG. 2 may also be worn by a monitoring person, with the main imaging apparatus arranged to image a target region to be monitored. The camera platform allows the imaging direction of the main imaging apparatus to be moved at least within the range of the monitoring target. When the sub imaging apparatus, the main imaging apparatus, and the camera platform are configured in such a manner, the main imaging apparatus can follow and image a monitoring target person that interests the monitoring person. If the monitoring target deviates from the imaging range of the main imaging apparatus, the user can still verify the monitoring target on the basis of the captured image generated by the imaging section of the sub imaging apparatus. Thus, as long as the user continuously faces the monitoring target, the main imaging apparatus can continuously image the monitoring target.

The series of the processes described above may be executed by hardware, by software, or by a combination of both. In a case where the software-based processing is to be carried out, the program recording the process sequences involved may be installed into an internal memory of a computer built with dedicated hardware for program execution. Alternatively, the program may be installed into a general-purpose computer capable of performing diverse processes of the installed program.

For example, the program may be recorded beforehand on a hard disc, an SSD (Slid State Drive), or ROM (Read Only Memory) acting as recording media. Alternatively, the program may be recorded temporarily or permanently on removable recording media such as flexible discs, CD-ROM (Compact Disc Read Only Memory), MO (Magneto optical) discs, DVD (Digital Versatile Disc), BD (Blu-Ray Disc (registered trademark)), magnetic discs, or semiconductor memory cards. Such removable recording media may be offered as what is generally called packaged software.

As another alternative, besides being installed from the removable recording media into the computer, the program may be transferred from a download site to the computer in a wired or wireless manner via networks such as LAN (Local Area Network) or the Internet. The computer can receive the program thus transferred and install the received program onto recording media such as an internal hard disc.

It is to be noted that the advantageous effects stated in this description are only examples and not limitative of the present technology that may also provide other advantages. The present technology should not be interpreted restrictively in accordance with the above-described embodiments of the technology. The embodiments of this technology are disclosed as examples, and it is obvious that those skilled in the art will easily conceive variations or alternatives of the embodiments within the scope of the technical idea stated in the appended claims. That is, the scope of the disclosed technology should be determined by the appended claims and their legal equivalents, rather than by the examples given.

The image processing apparatus according to the present technology may be configured preferably as follows:

(1)

An image processing apparatus including:

an image combination section configured to generate a display image by combining a sub captured image generated by a sub imaging apparatus imaging a subject, with a main captured image generated by a main imaging apparatus imaging the subject, the main imaging apparatus being remotely controlled by the sub imaging apparatus.

(2)

The image processing apparatus as stated in paragraph (1) above,

in which the sub captured image generated by the sub imaging apparatus has an angle of view different from that of the main captured image generated by the main imaging apparatus.

(3)

The image processing apparatus as stated in paragraph (1) or (2) above, further including:

a parallax calculation section configured to calculate a parallax between the main imaging apparatus and the sub imaging apparatus at a time of imaging the subject,

in which the image combination section switches an image combination operation according to the parallax calculated by the parallax calculation section.

(4)

The image processing apparatus as stated in paragraph (3) above,

in which the image combination section switches the image combination operation depending either on a result of comparison between the parallax calculated by the parallax calculation section on one hand and a predetermined first threshold value on the other hand, or on a result of comparison between the parallax on one hand and the first threshold value and a second threshold value larger than the first threshold value on the other hand.

(5)

The image processing apparatus as stated in paragraph (4) above,

in which, in a case where the parallax calculated by the parallax calculation section is equal to or smaller than the first threshold value, the image combination section generates the display image by combining the sub captured image with the main captured image.

(6)

The image processing apparatus as stated in paragraph (5) above,

in which the image combination section generates the display image by superposing on either the sub captured image or the main captured image, whichever has a wider angle of view, the other captured image.

(7)

The image processing apparatus as stated in paragraph (5) above,

in which the image combination section generates the display image by scaling down either the sub captured image or the main captured image, whichever has a wider angle of view, and by superposing the scaled-down captured image on the other captured image.

(8)

The image processing apparatus as stated in any one of paragraphs (4) through (7) above,

in which, in a case where the parallax calculated by the parallax calculation section is larger than the first threshold value and is equal to or smaller than the second threshold value, the image combination section generates the display image by superposing on either the sub captured image or the main captured image, whichever has a wider angle of view, an imaging region indication indicative of an imaging range of the other captured image.

(9)

The image processing apparatus as stated in paragraph (8) above,

in which the sub captured image has a wider angle of view than the main captured image, and

the image combination section generates the display image by superposing on the sub captured image the imaging region indication indicative of the range imaged by the main imaging apparatus.

(10)

The image processing apparatus as stated in any one of paragraphs (4) through (9) above,

in which, in a case where the parallax calculated by the parallax calculation section is larger than the second threshold value, the image combination section generates the display image by placing on either the sub captured image or the main captured image a focus position indication indicative of a focus position of the other captured image.

(11)

The image processing apparatus as stated in paragraph (10) above,

in which the sub captured image has a wider angle of view than the main captured image, and

the image combination section generates the display image by superposing on the sub captured image the focus position indication indicative of the focus position of the main imaging apparatus.

(12)

The image processing apparatus as stated in any one of paragraphs (3) through (11) above,

in which the parallax calculation section calculates the parallax at the time when the subject is imaged by the sub imaging apparatus and by the main imaging apparatus on the basis of a distance to the subject imaged by the sub imaging apparatus and of a motion following an initial state in which the sub imaging apparatus and the main imaging apparatus are placed.

(13)

The image processing apparatus as stated in any one of paragraphs (1) through (12) above, further including:

a detection section configured to detect an image viewing motion,

in which the image combination section generates the display image in response to the detected motion to view the display image at the detection section.

### REFERENCE SIGNS LIST

10: Imaging system
20: Main imaging apparatus
21, 73: Imaging optical system block
22, 74: Imaging section
23: Image processing section
24, 72: Communication section
25, 77: Display section
26: Recording section
27: Output section
28: Position and posture detection section
30: Control section
31: Imaging control section
40: Camera platform
60: Sub imaging apparatus
61: Hold section
62: Arm section
63: Eyepiece block
64: Circuit block
65: Power supply section
71: Subject position information generation section
75: Parallax calculation section
76: Image combination section
311: Subject position calculation section
312: Imaging direction control section
313: Focus control section
610: Neck band
611L, 611R: Ear pad
711: Distance measurement section
712: Motion sensor section

1. An image processing apparatus comprising:
an image combination section configured to generate a display image by combining a sub captured image generated by a sub imaging apparatus imaging a subject, with a main captured image generated by a main imaging apparatus imaging the subject, the main imaging apparatus being remotely controlled by the sub imaging apparatus.

2. The image processing apparatus according to claim 1,
wherein the sub captured image generated by the sub imaging apparatus has an angle of view different from that of the main captured image generated by the main imaging apparatus.

3. The image processing apparatus according to claim 1, further comprising:
a parallax calculation section configured to calculate a parallax between the main imaging apparatus and the sub imaging apparatus at a time of imaging the subject,
wherein the image combination section switches an image combination operation according to the parallax calculated by the parallax calculation section.

4. The image processing apparatus according to claim 3,
wherein the image combination section switches the image combination operation depending either on a result of comparison between the parallax calculated by the parallax calculation section on one hand and a predetermined first threshold value on the other hand, or on a result of comparison between the parallax on one hand and the first threshold value and a second threshold value larger than the first threshold value on the other hand.

5. The image processing apparatus according to claim 4,
wherein, in a case where the parallax calculated by the parallax calculation section is equal to or smaller than the first threshold value, the image combination section generates the display image by combining the sub captured image with the main captured image.

6. The image processing apparatus according to claim 5,
wherein the image combination section generates the display image by superposing on either the sub captured image or the main captured image, whichever has a wider angle of view, the other captured image.

7. The image processing apparatus according to claim 5,
wherein the image combination section generates the display image by scaling down either the sub captured image or the main captured image, whichever has a wider angle of view, and by superposing the scaled-down captured image on the other captured image.

8. The image processing apparatus according to claim 4,
wherein, in a case where the parallax calculated by the parallax calculation section is larger than the first threshold value and is equal to or smaller than the second threshold value, the image combination section generates the display image by superposing on either the sub captured image or the main captured image, whichever has a wider angle of view, an imaging region indication indicative of an imaging range of the other captured image.

9. The image processing apparatus according to claim 8,
wherein the sub captured image has a wider angle of view than the main captured image, and
the image combination section generates the display image by superposing on the sub captured image the imaging region indication indicative of the range imaged by the main imaging apparatus.

10. The image processing apparatus according to claim 4,
wherein, in a case where the parallax calculated by the parallax calculation section is larger than the second threshold value, the image combination section generates the display image by placing on either the sub captured image or the main captured image a focus position indication indicative of a focus position of the other captured image.

11. The image processing apparatus according to claim 10,
wherein the sub captured image has a wider angle of view than the main captured image, and
the image combination section generates the display image by superposing on the sub captured image the focus position indication indicative of the focus position of the main imaging apparatus.

12. The image processing apparatus according to claim 3,
wherein the parallax calculation section calculates the parallax at the time when the subject is imaged by the sub imaging apparatus and by the main imaging apparatus on a basis of a distance to the subject imaged by the sub imaging apparatus and of a motion following an initial state in which the sub imaging apparatus and the main imaging apparatus are placed.

13. The image processing apparatus according to claim 1, further comprising:
a detection section configured to detect an image viewing motion,
wherein the image combination section generates the display image in response to the detected motion to view the display image at the detection section.

14. An imaging processing method comprising:
causing an image combination section to generate a display image by combining a sub captured image generated by a sub imaging apparatus imaging a subject, with a main captured image generated by a main imaging apparatus imaging the subject, the main imaging apparatus being remotely controlled by the sub imaging apparatus.

15. A program for causing a computer to perform a procedure of:
generating a display image by combining a sub captured image generated by a sub imaging apparatus imaging a subject, with a main captured image generated by a main imaging apparatus imaging the subject, the main imaging apparatus being remotely controlled by the sub imaging apparatus.

16. An imaging apparatus comprising:
an imaging section configured to image a subject;
a distance measurement section configured to measure a distance to the subject imaged by the imaging section;
a motion sensor section configured to measure a motion following an initial state;
a communication section configured to transmit to a main imaging apparatus the distance measured by the distance measurement section and subject position information indicative of the motion measured by the motion sensor section;
an image combination section configured to generate a display image by combining a sub captured image generated by the imaging section, with a main captured image generated by the main imaging apparatus of which an imaging direction is controlled on a basis of the subject position information; and
a display section configured to display the display image generated by the image combination section.

17. The imaging apparatus according to claim 16,
wherein the initial state is a state in which the distance measurement section and the main imaging apparatus are made to face each other, and
the distance to the main imaging apparatus as measured by the distance measurement section and the direction of the main imaging apparatus are used as a reference for the motion.

18. The imaging apparatus according to claim 16, further comprising:
a hold section configured to hold the display section, the imaging section, and the distance measurement section in such a manner that the display section is positioned at an eye of a user, that the imaging section is positioned to image what appears straight in front of the user, and that the distance measurement section is positioned to measure the distance to the subject straight in front of the user.

19. The imaging apparatus according to claim 16, further comprising:
a detection section configured to detect an image viewing motion,
wherein the image combination section generates the display image in response to the detected motion to view the display image at the detection section.
